(19) United States
(12) Patent Application Publication
(10) Pub. No.: US 2023/0244501 A1
(43) Pub. Date: Aug. 3, 2023

(54) PROGRAM KILLING SYSTEM AND PROGRAM KILLING METHOD

(71) Applicant: ASUSTeK COMPUTER INC., Taipei (TW)

(72) Inventors: Yun-Hsuan LEE, Taipei (TW); Tse-Chih LIN, Taipei (TW)

(21) Appl. No.: 17/938,704

(22) Filed: Oct. 7, 2022

(30) Foreign Application Priority Data
Jan. 28, 2022 (TW) 111103789

(51) Int. Cl. G06F 9/445

(52) U.S. Cl. CPC G06F 9/44594; G06F 3/0482

(57) ABSTRACT

The disclosure discloses a program killing system including a memory and a processor. The processor obtains instructions from the memory to perform the following steps: collecting use counts, use times, and a first use order of programs; generating a first candidate list based on the plurality of use counts and the use times, generating a second candidate list based on the use counts, and generating a third candidate list based on the first use order; collecting a second use order of the programs in an operation time to generate an operation list; comparing each of the first candidate list, the second candidate list, and the third candidate list with the operation list to produce a comparison result; and outputting one of the first candidate list, the second candidate list, or the third candidate list as a judgment list according to the comparison result.

### CROSS-REFERENCE TO RELATED APPLICATION

This application claims the priority benefit of Taiwan Application Serial No. 111103789, filed on Jan. 28, 2022. The entirety of the above-mentioned patent application is hereby incorporated by reference herein and made a part of the specification.

### BACKGROUND OF THE INVENTION

### Field of the Invention

The disclosure relates to a killing system and a killing method, and in particular, to a program killing system and a program killing method.

### Description of the Related Art

When an application returns to the background, the system grants the application a lower process priority. It is easy for the lower process priority to be killed by the low memory killer. After the application is killed, a user needs to wait for a relatively long time before using the application again.

### BRIEF SUMMARY OF THE INVENTION

According to the first aspect of this disclosure, a program killing system is provided. The program killing system is applicable to a portable electronic device, and the program killing system includes a memory and a processor. The memory is configured to store a plurality of instructions. The processor is configured to obtain the plurality of instructions from the memory to perform the following steps: collecting a plurality of use counts, a plurality of use times, and a first use order of a plurality of programs; generating a first candidate list based on the plurality of use counts and the plurality of use times, generating a second candidate list based on the plurality of use counts, and generating a third candidate list based on the first use order; collecting a second use order of the plurality of programs in an operation time to generate an operation list; comparing each of the first candidate list, the second candidate list, and the third candidate list with the operation list to produce a comparison result; outputting one of the first candidate list, the second candidate list, or the third candidate list as a judgment list according to the comparison result; and killing a plurality of target programs in the plurality of programs based on the judgment list.

According to the second aspect of this disclosure, a program killing method is provided. The program killing method includes the following steps: collecting a plurality of use counts, a plurality of use times, and a first use order of a plurality of programs; generating a first candidate list based on the plurality of use counts and the plurality of use times, a second candidate list based on the plurality of use counts, and generating a third candidate list based on the first use order; collecting a second use order of the plurality of programs in an operation time to generate an operation list; comparing each of the first candidate list, the second candidate list, and the third candidate list with the operation list to produce a comparison result; outputting one of the first candidate list, the second candidate list, or the third candidate list as a judgment list according to the comparison result; and killing a plurality of target programs in the plurality of programs based on the judgment list.

Therefore, according to the technical content of the disclosure, through the program killing system and the program killing method illustrated in the embodiments of the disclosure, user's recent usage of applications is self-learned, and a candidate list is generated, to reduce the case in which a program in the candidate list or a program with a high priority is killed.

After referring to the following embodiments, a person of ordinary skill in the art to which the disclosure belongs easily understands the basic spirit and other objectives of the disclosure, as well as the technical means and implementation aspects adopted in the disclosure.

### BRIEF DESCRIPTION OF THE DRAWINGS

To make the foregoing and other objectives, features, advantages, and embodiments of the disclosure and embodiments more obvious and comprehensible, the accompanying drawings are described as follows:

FIG. 1 illustrates a schematic diagram of a program killing system according to an embodiment of the disclosure;

FIG. 2 illustrates a usage scenario of a program killing system according to an embodiment of the disclosure;

FIG. 3 illustrates a usage scenario of a program killing system according to an embodiment of the disclosure; and

FIG. 4 illustrates a flowchart of a program killing method according to an embodiment of the disclosure.

According to common practice, the various features and elements in the figures are not drawn to scale, but are drawn in a manner that best represents the specific features and elements relevant to the disclosure. In addition, similar elements/components are referred to by the same or similar reference signs among the different drawings.

### DETAILED DESCRIPTION OF THE EMBODIMENTS

To make the descriptions of the disclosure more thorough and complete, implementation aspects and specific embodiments of the disclosure are described below in an illustrative manner. However, the implementation aspects and specific embodiments are not exclusive forms of implementing or using the specific embodiments of the disclosure. The features of various specific embodiments as well as method steps and sequences for constructing and operating these specific embodiments are encompassed in DETAILED DESCRIPTION OF THE EMBODIMENTS. However, other embodiments are also utilized to achieve the same or equivalent functions and sequence of steps.

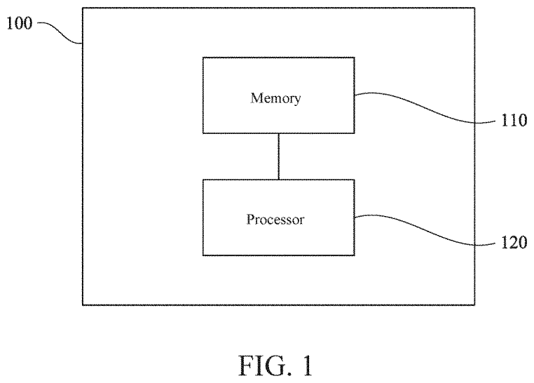

Referring to FIG. 1, a program killing system 100 includes a memory 110 and a processor 120. In terms of connection relationship, the memory 110 is coupled to the processor 120.

To provide a technology of self-learning user's recent usage of applications and generating a candidate list, the disclosure provides the program killing system 100 shown in FIG. 1, and the related operations are described below in detail.

In operation, in an embodiment, the memory 110 is configured to store a plurality of instructions. The processor 120 is configured to obtain a plurality of instructions from the memory 110 to perform the following steps: collecting a plurality of use counts, a plurality of use times, and a first use order of a plurality of programs; generating a first candidate list based on the plurality of use counts and the plurality of use times, generating a second candidate list based on the plurality of use counts, and generating a third candidate list based on the first use order; collecting a second use order of the plurality of programs in an operation time to generate an operation list; comparing each of the first candidate list, the second candidate list, and the third candidate list with the operation list to produce a comparison result; outputting one of the first candidate list, the second candidate list, or the third candidate list as a judgment list according to the comparison result; and killing a plurality of target programs in the plurality of programs based on the judgment list.

As shown in FIG. 1, in an embodiment, the processor 120 is configured to obtain a plurality of instructions from the memory 110 to collect a plurality of use counts, a plurality of use times, and a first use order of a plurality of programs. In an embodiment, the plurality of programs is a plurality of applications (apps), the plurality of use counts is use counts of the apps, the plurality of use times is use times of the apps, and the first use order is an order of apps most frequently used in the last 12 hours, but the disclosure is not limited thereto.

Then, the processor 120 generates a first candidate list based on the plurality of use counts and the plurality of use times, generates a second candidate list based on the plurality of use counts, and generates a third candidate list based on the first use order. In an embodiment, the first candidate list, the second candidate list, and the third candidate list respectively include a list of 10 apps. It should be noted that for the first candidate list, use counts and use times of apps are comprehensively considered, to avoid a misjudgment caused by using any parameter alone. In an embodiment, a single app is opened only once, but its use time lasts for several hours. If a judgment is made by using the use count of the app alone, a misjudgment occurs, but the disclosure is not limited thereto.

Then the processor 120 collects a second use order of the plurality of programs in an operation time to generate an operation list. In an embodiment, the operation time is one hour, the second use order is an order of apps most frequently used in the last hour, and the operation list is a list of 10 apps. To timely learn of the user's use habit to provide a candidate list most suitable for the user, apps most frequently used by the user in a recent operation time are collected, and are organized into an operation list for subsequent comparison and selection, but the disclosure is not limited thereto.

Then, the processor 120 compares each of the first candidate list, the second candidate list, and the third candidate list with the operation list to produce a comparison result. In an embodiment, the comparison result is that the first candidate list and the operation list have six same apps, the second candidate list and the operation list have seven same apps, and the third candidate list and the operation list have eight same apps, but the disclosure is not limited thereto.

Then, the processor 120 outputs one of the first candidate list, the second candidate list, or the third candidate list as a judgment list according to the comparison result. In an embodiment, when the first candidate list and the operation list have six same apps, the second candidate list and the operation list have seven same apps, and the third candidate list and the operation list have eight same apps, because the third candidate list and the operation list has the most same apps, the third candidate list is selected as the judgment list, but the disclosure is not limited thereto.

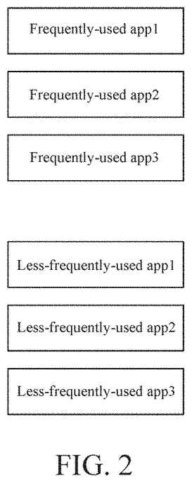

To make the kill operation of the program killing system 100 easy to understand, refer to FIG. 1 and FIG. 2 together. The processor 120 kills a plurality of target programs in the plurality of programs based on the judgment list. In an embodiment, referring to FIG. 2, when the processor 120 starts the low memory killer, the processor 120 performs the kill according to a mechanism of the judgment list. Using an example in which the judgment list is the third candidate list, the third candidate list is a mechanism of performing arrangement according to the use order. Therefore, the processor 120 kills the programs sequentially from back to front according to the use order of the programs. If there are six programs in the third candidate list, the processor 120 sequentially kills the sixth program (for example, less-frequently-used app3), the fifth program (for example, less-frequently-used app2), the fourth program (for example, less-frequently-used app1), and the like. Accordingly, the processor 120 kills the plurality of target programs based on the judgment list, but the disclosure is not limited thereto.

In an embodiment, the processor 120 further obtains a plurality of instructions from the memory 110 to obtain the use count of each of the plurality of programs. Then, the processor 120 calculates a use count proportion of a use count of each of the plurality of programs to the plurality of use counts of the plurality of programs. In an embodiment, a use count of app A is 8, and a use count of app B is 24. In a case that app A and app B are opened, a total use count is 32, so that a use count proportion of app A is 8÷32×100%=25%, a use count proportion of app B is 24÷32×100%=75%, but the disclosure is not limited thereto.

In an embodiment, the processor 120 further obtains a plurality of instructions from the memory 110 to obtain a use time of each of the plurality of programs. Then, the processor 120 calculates a use time proportion of the use time of the each of the plurality of programs to the plurality of use times of the plurality of programs. In an embodiment, a use time of app A is 6 minutes, and a use time of app B is 24 minutes. In a case that only app A and app B are opened, a total use time is 30 minutes, so that a use time proportion of app A is 6÷30×100%=20%, a use time proportion of app B is 24÷30×100%=80%, but the disclosure is not limited thereto.

In an embodiment, the processor 120 further obtains a plurality of instructions from the memory 110 to generate a first candidate list based on the use count proportion and the use time proportion. In an embodiment, when the use count proportion of app A is 50% and the use time proportion of app A is 50%, the use count proportion of app B is 30% and the use time proportion of app B is 30%, as well as the use count proportion of app C is 20% and the use time proportion of app C is 20%, a use weight of app A is 50+50=100, a use weight of app B is 30+30=60, and a use weight of app C is 20+20=40. If two apps are selected to be included in the first candidate list, since comprehensive use weights of the use count proportions and the use time proportions of app A and app B are higher than a comprehensive use weight of app C, there are app A and app B in the first candidate list, and app A has a priority higher than that of app B, but the disclosure is not limited thereto.

In an embodiment, the processor 120 further obtains a plurality of instructions from the memory 110 for execution to obtain a first use count of a first program in the plurality of programs. Then, the processor 120 calculates a first use count proportion of the first use count of the first program to the plurality of use counts of the plurality of programs.

In an embodiment, the processor 120 further obtains a plurality of instructions from the memory 110 to obtain a first use time of the first program in the plurality of programs. Then, the processor 120 calculates a first use time proportion of the first use time of the first program to the plurality of use times of the plurality of programs.

In an embodiment, the processor 120 further obtains a plurality of instructions from the memory 110 to obtain a second use count of a second program in the plurality of programs. Then, the processor 120 calculates a second use count proportion of the second use count of the second program to the plurality of use counts of the plurality of programs.

In an embodiment, the processor 120 further obtains a plurality of instructions from the memory 110 to obtain a second use time of a second program in the plurality of programs. Then, the processor 120 calculates a second use time proportion of the second use time of the second program to the plurality of use times of the plurality of programs.

In an embodiment, the processor 120 further obtains a plurality of instructions from the memory 110 to obtain a first program use weight of the first program based on the first use count proportion and the first use time proportion. Then, the processor 120 obtains a second program use weight of the second program based on the second use count proportion and the second use time proportion. Then, the processor 120 generates the first candidate list based on the first program use weight and the second program use weight. In an embodiment, the first program is app A, and when a use count proportion of app A is 50% and a use time proportion of app A is 50%, a use weight of app A is 50+50=100. The second program is app B, and when a use count proportion of app B is 30% and a use time proportion of app B is 30%, a use weight of app B is 30+30=60. The third program is app C, and when a use count proportion of app C is 20% and a use time proportion of app C is 20%, a use weight of app C is 20+20=40. If two apps are selected to be included in the first candidate list, since comprehensive use weights of the use count proportions and the use time proportions of app A and app B are higher than a comprehensive use weight of app C, there are app A and app B in the first candidate list, and app A has a priority higher than that of app B, but the disclosure is not limited thereto.

Referring to FIG. 1 and FIG. 2 together, in an embodiment, the processor 120 further obtains a plurality of instructions from the memory 110 to perform the following step: preferentially killing, when the plurality of programs has a low priority or a high priority, a plurality of programs with the low priority.

Then, the processor 120 grants, based on the judgment list, a plurality of target programs in the judgment list with the high priority. Then, the processor 120 grants, based on the judgment list, a plurality of target programs in the plurality of programs with the low priority. In an embodiment, the processor 120 grants the high priority or the low priority according to the mechanism of the judgment list. Using an example in which the judgment list is the third candidate list, the third candidate list is a mechanism of performing arrangement according to the use order. Therefore, the processor 120 grants, according to the use order of the programs, frequently-used app1, frequently-used app2, and frequently-used app3 that are recently used in the judgment list with the high priority. Then, the processor 120 grants, according to the mechanism of the use order adopted in the judgment list, less-frequently-used app1, less-frequently-used app2 and less-frequently-used app3 that are not frequently used recently in the judgment list with the low priority.

Further, the processor 120 kills the plurality of target programs with the low priority based on the judgment list. In an embodiment, when the processor 120 starts the low memory killer, the processor 120 performs the kill according to the mechanism of the judgment list. Using an example in which the judgment list is the third candidate list, the third candidate list is a mechanism of performing arrangement according to the use order. Therefore, the processor 120 kills the programs sequentially from back to front according to the use order of the programs. If there are six programs in the third candidate list, the processor 120 sequentially kills the sixth program (for example, less-frequently-used app3), the fifth program (for example, less-frequently-used app2), the fourth program (for example, less-frequently-used app1), and the like. Accordingly, the processor 120 kills the plurality of target programs with the low priority based on the judgment list, but the disclosure is not limited thereto.

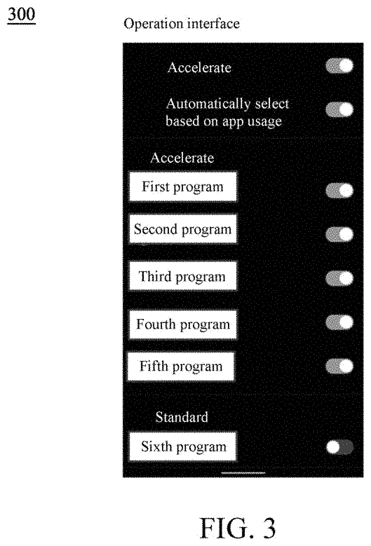

Referring to FIG. 3, in an embodiment, the program killing system 100 includes an operation interface 300. In an embodiment, the user customizes priorities of programs through a virtual button on the operation interface 300, so that a program with a high priority is not killed.

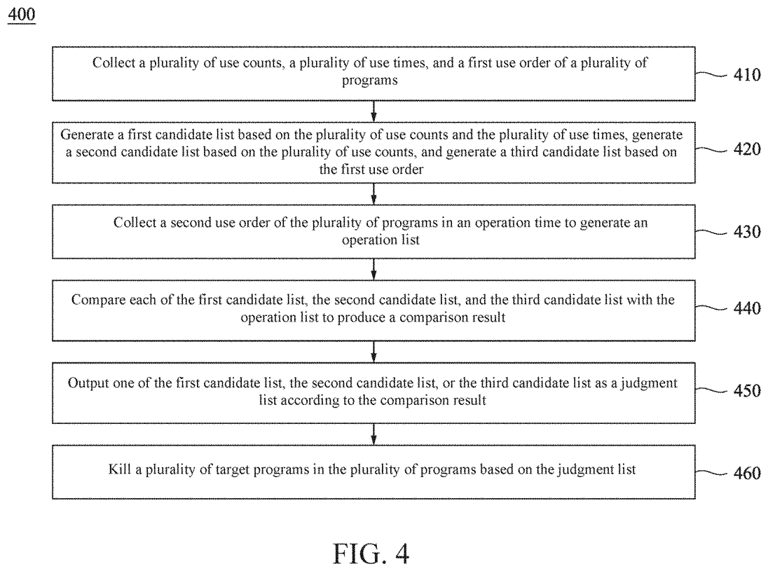

FIG. 4 illustrates a flowchart of a program killing method according to an embodiment of the disclosure. The program killing method 400 includes the following steps:

Step 410: Collect a plurality of use counts, a plurality of use times, and a first use order of a plurality of programs.

Step 420: Generate a first candidate list based on the plurality of use counts and the plurality of use times, generate a second candidate list based on the plurality of use counts, and generate a third candidate list based on the first use order.

Step 430: Collect a second use order of the plurality of programs in an operation time to generate an operation list.

Step 440: Compare each of the first candidate list, the second candidate list, and the third candidate list with the operation list to produce a comparison result.

Step 450: Output one of the first candidate list, the second candidate list, or the third candidate list as a judgment list according to the comparison result.

Step 460: Kill a plurality of target programs in the plurality of programs based on the judgment list.

To make the program killing method 400 easy to understand, refer to FIG. 1, FIG. 2 and FIG. 4 together. In step 410, the processor 120 collects a plurality of use counts, a plurality of use times, and a first use order of the plurality of programs. Then, referring to step 420, the processor 120 generates a first candidate list based on the plurality of use counts and the plurality of use times, generates a second candidate list based on the plurality of use counts, and generates a third candidate list based on the first use order. Then, referring to step 430, the processor 120 collects a second use order of the plurality of programs in an operation time to generate the operation list. Then, referring to the step 440, the processor 120 compares each of the first candidate list, the second candidate list, and the third candidate list with the operation list to produce a comparison result. Then, referring to step 450, the processor 120 outputs one of the first candidate list, the second candidate list, or the third candidate list as a judgment list according to the comparison result. Further, referring to step 460, the processor 120 kills a plurality of target programs in the plurality of programs based on the judgment list.

In an embodiment, referring to step 410, the processor 120 further obtains a use count of each of the plurality of programs. Then, the processor 120 calculates a use count proportion of the use count of the each of the plurality of programs to the plurality of use counts of the plurality of programs. In another embodiment, referring to step 410, the processor 120 further obtains a use time of each of the plurality of programs. Then, the processor 120 calculates a use time proportion of the use time of the each of the plurality of programs to the plurality of use times of the plurality of programs. In an embodiment, referring to step 420, the processor 120 further generates a first candidate list according to the use count proportion and the use time proportion. In an embodiment, it is assumed that two apps are selected to be included in the first candidate list, and all apps include app A, app B, and app C. If comprehensive use weights of use count proportions and use time proportions of app A and app B are higher than a comprehensive use weight of app C, and a comprehensive use weight of app A is higher than that of app B, app A and app B are included in the first candidate list, and app A has a priority higher than that of app B, but the disclosure is not limited thereto. It should be noted that for the foregoing first candidate list, the use counts and the use times of apps are comprehensively considered, to avoid a misjudgment caused by using any parameter alone.

In an embodiment, referring to step 410, the processor 120 further obtains a first use count of a first program in the plurality of programs. Then, the processor 120 calculates a first use count proportion of the first use count of the first program to the plurality of use counts of the plurality of programs. In another embodiment, referring to step 410, the processor 120 further obtains a first use time of the first program in the plurality of programs. Then, the processor 120 calculates a first use time proportion of the first use time of the first program to the plurality of use times of the plurality of programs.

In an embodiment, referring to step 410, the processor 120 further obtains a second use count of the second program in the plurality of programs. Then, the processor 120 calculates a second use count proportion of the second use count of the second program to the plurality of use counts of the plurality of programs. In another embodiment, referring to step 410, the processor 120 further obtains a second use time of the second program in the plurality of programs. Then, the processor 120 calculates a second use time proportion of the second use time of the second program to the plurality of use times of the plurality of programs.

In an embodiment, referring to step 420, the processor 120 further obtain a first program use weight of the first program according to the first use count proportion and the first use time proportion. Then, the processor 120 obtains a second program use weight of the second program based on the second use count proportion and the second use time proportion. Then, the processor 120 generates the first candidate list based on the first program use weight and the second program use weight. In an embodiment, the first program is app A, the second program is app B, and the third program is app C. In a case that two apps are selected to be included in the first candidate list, if a first use weight of app A is higher than a second use weight of app B and a third use weight of app C, and the second use weight of app B is higher than the third use weight of app C, app A and app B are included in the first candidate list, and app A has a priority higher than that of app B, but the disclosure is not limited thereto.

In an embodiment, referring to step 460, the processor 120 further preferentially kills, when the plurality of programs has a low priority or a high priority, a plurality of programs with the low priority. Then, the processor 120 grants, based on the judgment list, a plurality of target programs in the judgment list with the high priority. Then, the processor 120 grants, based on the judgment list, a plurality of target programs in the plurality of programs with the low priority. Further, the processor 120 kills the plurality of target programs with the low priority based on the judgment list. In an embodiment, referring to FIG. 1 and FIG. 2 together, using an example in which the judgment list is the third candidate list, the third candidate list is a mechanism of performing arrangement according to the use order. Therefore, the processor 120 grants, according to the use order of the programs, frequently-used app1, frequently-used app2, and frequently-used app3 that are used recently in the judgment list with the high priority. Then, the processor 120 grants, according to the mechanism of the use order adopted in the judgment list, less-frequently-used app1, less-frequently-used app2 and less-frequently-used app3 that are not frequently used recently in the judgment list with the low priority.

In an embodiment, referring to FIG. 1 and FIG. 4 together, in the program killing method 400, the processor 120 further detects a capacity of the memory 110, and when the capacity of the memory 110 is smaller than a capacity threshold, the processor 120 kills the plurality of programs with the low priority.

It is learned from the foregoing embodiments of the disclosure that the application of the disclosure has the following advantages. The disclosure provides a program killing system and a program killing method to self-learn user's recent usage of applications and generate a candidate list. Therefore, the case in which a program in the candidate list or a program with a high priority is killed is reduced.

Although specific embodiments of the disclosure are disclosed above in DETAILED DESCRIPTION OF THE EMBODIMENTS, the embodiments are not intended to limit the disclosure. A person of ordinary skill in the art to which the disclosure belongs can make some changes and modifications on the disclosure without departing from the principle and spirit of the disclosure. Therefore, the protection scope of the disclosure is subject to that defined by the appended claims.

What is claimed is:

1. A program killing system, applicable to a portable electronic device, comprising:
a memory, configured to store a plurality of instructions; and
a processor, configured to obtain the instructions from the memory to perform the following steps:
collecting a plurality of use counts, a plurality of use times, and a first use order of a plurality of programs;
generating a first candidate list based on the use counts and the use times, generating a second candidate list based on the use counts, and generating a third candidate list based on the first use order;
collecting a second use order of the programs in an operation time to generate an operation list;
comparing each of the first candidate list, the second candidate list, and the third candidate list with the operation list to produce a comparison result;
outputting one of the first candidate list, the second candidate list, or the third candidate list as a judgment list according to the comparison result; and
killing a plurality of target programs in the programs according to the judgment list.

2. The program killing system according to claim 1, wherein the processor is further configured to obtain the instructions from the memory to perform the following steps:
obtaining the use count of each of the programs; and
calculating a use count proportion of the use count of the each of the programs to the use counts of the programs.

3. The program killing system according to claim 2, wherein the processor is further configured to obtain the instructions from the memory to perform the following steps:
obtaining the use time of each of the programs; and
calculating a use time proportion of the use time of the each of the programs to the use times of the programs.

4. The program killing system according to claim 3, wherein the processor is further configured to obtain the instructions from the memory to perform the following step:
generating the first candidate list based on the use count proportion and the use time proportion.

5. The program killing system according to claim 1, wherein the processor is further configured to obtain the instructions from the memory to perform the following steps:
obtaining a first use count of a first program in the programs; and
calculating a first use count proportion of the first use count of the first program to the use counts of the programs.

6. The program killing system according to claim 5, wherein the processor is further configured to obtain the instructions from the memory to perform the following steps:
obtaining a first use time of the first program in the programs; and
calculating a first use time proportion of the first use time of the first program to the use times of the programs.

7. The program killing system according to claim 6, wherein the processor is further configured to obtain the instructions from the memory to perform the following steps:
obtaining a second use count of a second program in the programs; and
calculating a second use count proportion of the second use count of the second program to the use counts of the programs.

8. The program killing system according to claim 7, wherein the processor is further configured to obtain the instructions from the memory to perform the following steps:
obtaining a second use time of the second program in the programs; and
calculating a second use time proportion of the second use time of the second program to the use times of the programs.

9. The program killing system according to claim 8, wherein the processor is further configured to obtain the instructions from the memory to perform the following steps:
obtaining a first program use weight of the first program based on the first use count proportion and the first use time proportion;
obtaining a second program use weight of the second program based on the second use count proportion and the second use time proportion; and
generating the first candidate list based on the first program use weight and the second program use weight.

10. The program killing system according to claim 1, wherein the processor is further configured to obtain the instructions from the memory to perform the following steps:
preferentially killing, when the programs have a low priority or a high priority, the programs with the low priority;
granting a plurality of target programs in the judgment list with the high priority according to the judgment list;
granting the target programs in the programs with the low priority according to the judgment list; and
killing the target programs with the low priority according to the judgment list.

11. A program killing method, comprising:
collecting a plurality of use counts, a plurality of use times, and a first use order of a plurality of programs;
generating a first candidate list based on the use counts and the use times, generating a second candidate list based on the use counts, and generating a third candidate list based on the first use order;
collecting a second use order of the programs in an operation time to generate an operation list;
comparing each of the first candidate list, the second candidate list, and the third candidate list with the operation list to produce a comparison result;
outputting one of the first candidate list, the second candidate list, or the third candidate list as a judgment list according to the comparison result; and
killing a plurality of target programs in the programs according to the judgment list.

12. The program killing method according to claim 11, wherein the step of collecting the use counts, the use times, and the first use order of the programs comprises:
obtaining the use count of each of the programs; and
calculating a use count proportion of the use count of the each of the programs to the use counts of the programs.

13. The program killing method according to claim 12, wherein the step of collecting the use counts, the use times, and the first use order of the programs further comprises:
obtaining the use time of each of the programs; and
calculating a use time proportion of the use time of the each of the programs to the use times of the programs.

14. The program killing method according to claim 13, wherein the step of generating the first candidate list based on the use counts and the use times further comprises:
generating the first candidate list based on the use count proportion and the use time proportion.

15. The program killing method according to claim 11, wherein the step of collecting the use counts, the use times, and the first use order of the programs comprises:
obtaining a first use count of a first program in the programs; and
calculating a first use count proportion of the first use count of the first program to the use counts of the programs.

16. The program killing method according to claim 15, wherein the step of collecting the use counts, the use times, and the first use order of the programs further comprises:
obtaining a first use time of the first program in the programs; and
calculating a first use time proportion of the first use time of the first program to the use times of the programs.

17. The program killing method according to claim 16, wherein the step of collecting the use counts, the use times, and the first use order of the programs further comprises:
obtaining a second use count of a second program in the programs; and
calculating a second use count proportion of the second use count of the second program to the use counts of the programs.

18. The program killing method according to claim 17, wherein the step of collecting the use counts, the use times, and the first use order of the programs further comprises:
obtaining a second use time of the second program in the programs; and
calculating a second use time proportion of the second use time of the second program to the use times of the programs.

19. The program killing method according to claim 18, wherein the step of generating the first candidate list based on the use counts and the use times comprises:
obtaining a first program use weight of the first program based on the first use count proportion and the first use time proportion;
obtaining a second program use weight of the second program based on the second use count proportion and the second use time proportion; and
generating the first candidate list based on the first program use weight and the second program use weight.

20. The program killing method according to claim 11, wherein the step of killing the target programs in the programs according to the judgment list comprises:
preferentially killing, when the programs have a low priority or a high priority, the programs with the low priority;
granting a plurality of target programs in the judgment list with the high priority according to the judgment list;
granting the target programs in the programs with the low priority according to the judgment list; and
killing the target programs with the low priority according to the judgment list.
